(19) United States
(12) Patent Application Publication
(10) Pub. No.: US 2012/0068532 A1
(43) Pub. Date: Mar. 22, 2012

(54) POWER SUPPLY APPARATUS AND VEHICLE

(75) Inventors: Yukinari Tanabe, Miyoshi-shi (JP); Toshiyuki Kawai, Toyohashi-shi (JP)

(73) Assignee: TOYOTA JIDOSHA KABUSHIKI KAISHA, Toyota-shi, Aichi-ken (JP)

(21) Appl. No.: 13/321,983

(22) PCT Filed: Apr. 29, 2010
(86) PCT No.: PCT/IB10/00970

§ 371 Date: Nov. 22, 2011

(30) Foreign Application Priority Data
Jun. 1, 2009 (JP) 2009-132082

(51) Int. Cl. B60L 3/04; H02P 3/02; B60Q 1/00

(52) U.S. Cl. 307/10.1; 340/436; 318/400.3

(57) ABSTRACT

A relay that is electrically connected/disconnected to/from a battery in parallel with a smoothing capacitor on an inverter side with respect to a system main relay is provided. Thus, when the system is turned off, the battery and electrode buses are electrically disconnected from each other by the system main relay, and the positive electrode bus is thereby connected to the negative electrode bus by the relay. As a result, electric power accumulated in the smoothing capacitor is more reliably and more swiftly discharged.

### BACKGROUND OF THE INVENTION

1. Field of the Invention

The invention relates to a power supply apparatus and a vehicle equipped with the power supply apparatus, and more specifically, to a power supply apparatus that exchanges electric power with an electric machine and a vehicle equipped with the power supply apparatus.

2. Description of the Related Art

A power supply apparatus may be mounted on a vehicle together with a motor that outputs drive power and an inverter for driving the motor. The power supply apparatus may also include a high-voltage secondary battery, a system main relay that electrically connects/disconnects the high-voltage secondary battery and the motor to/from each other, and a smoothing capacitor that is connected to the high-voltage secondary battery, in parallel with the motor on the motor side with respect to the system main relay (e.g., see Published Japanese Translation of PCT Application No. 8-511153 (JP-A-8-511153)). In this apparatus, if it is determined that a collision of the vehicle will occur, the system main relay is turned off, and the inverter is driven to discharge electric power that has accumulated in the smoothing capacitor. Thus, the risk of receiving an electric shock upon the collision of the vehicle is reduced.

However, in the above power supply apparatus, the inverter needs to be driven in order to discharge the electric power accumulated in the smoothing capacitor. Therefore, the electric power cannot be discharged when the inverter or a control device for controlling the inverter has malfunctioned. Further, in order to discharge the electric, power accumulated in the smoothing capacitor, it is also conceivable to provide a discharge resistor in parallel with the smoothing capacitor. However, a great loss is caused during normal operation if the discharge resistor has a low resistance. Conversely, it takes a long time to discharge the accumulated electric power if the resistance of the discharge resistor is high.

### SUMMARY OF THE INVENTION

The invention provides a power supply apparatus that more reliably and more swiftly discharges electric power accumulated in a smoothing capacitor, and a vehicle equipped with the power supply apparatus.

A first aspect of the invention relates to a power supply apparatus that exchanges an electric power with an electric machine. This power supply apparatus is equipped with a direct-current power supply, a first relay device that electrically selectively connects the direct-current power supply to the electric machine, a smoothing capacitor that is connected in parallel with the direct-current power supply and provided between the first relay device and the electric machine, and a second relay device that is connected to the direct-current power supply in parallel with the smoothing capacitor on the electric machine side with respect to the first relay device and that electrically selectively connects the smoothing capacitor.

This power supply apparatus according to the invention is provided with the second relay device that is electrically connected/disconnected to/from the direct-current power supply in parallel with the smoothing capacitor on the electric machine side with respect to the first relay device. Thus, when the direct-current power supply and the electric machine are disconnected from each other by the first relay device, the electric power accumulated in the smoothing capacitor can be more reliably and more swiftly discharged by electrically connecting the second relay device. It should be noted herein that “the first relay device” and “the second relay device” may also be relays.

A second aspect of the invention relates to a vehicle. This vehicle is equipped with a power supply apparatus that exchanges an electric power with an electric machine, and an electric motor as the electric machine to/from which a running motive power can be input/output. The power supply apparatus is equipped with a direct-current power supply, a first relay device that electrically selectively connects the direct-current power supply to the electric machine, a smoothing capacitor that is connected in parallel with the direct-current power supply and provided between the first relay device and the electric machine, and a second relay device that is connected to the direct-current power supply in parallel with the smoothing capacitor on the electric machine side with respect to the first relay device side and that selectively connects the smoothing capacitor.

The vehicle according to the invention is equipped with the power supply apparatus according to the foregoing aspect of the invention, and hence can achieve an effect similar to that of the power supply apparatus according to the invention, for example, the effect of making it possible to more reliably and more swiftly discharge the electric power accumulated in the smoothing capacitor or the like.

### BRIEF DESCRIPTION OF THE DRAWINGS

The foregoing and further features and advantages of the invention will become apparent from the following description of an example embodiment with reference to the accompanying drawings, wherein like numerals are used to represent like elements and wherein:

FIG. 1 is a block diagram that shows the overall configuration of an electric vehicle equipped with a power supply apparatus according to the embodiment of the invention;

FIG. 2 is a schematic diagram of an example configuration of a relay constituting part of a system main relay and a relay;

FIG. 3 is a schematic diagram of an example construction of the relay that constitutes part of the system main relay and a relay;

FIG. 4 is a schematic diagram of an example configuration of the relay that constitutes part of the system main relay and a relay according to a modified embodiment of invention;

FIG. 5 is a schematic diagram of an example configuration of the relay that constitutes part of the system main relay and the relay according to the modified embodiment of the invention; and

FIG. 6 is a block diagram of the overall configuration of an electric vehicle according to the modified embodiment of the invention.

### DETAILED DESCRIPTION OF EMBODIMENT

Next, embodiments of the invention will be described using an embodiment thereof.

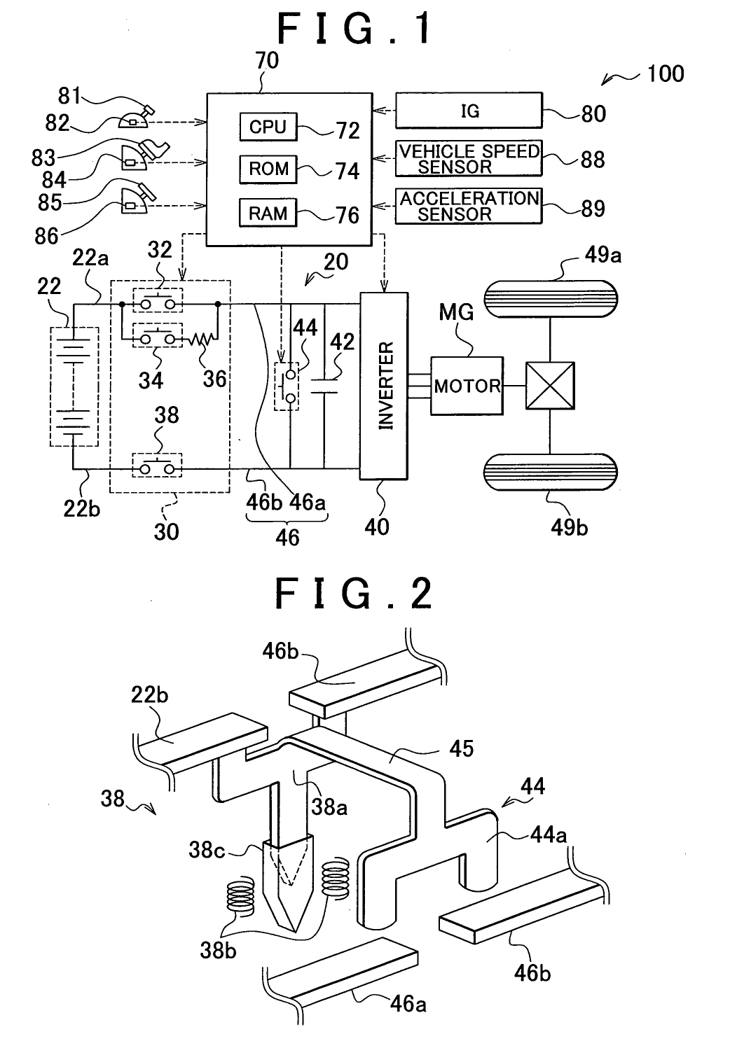

FIG. 1 is a block diagram showing the overall configuration of an electric vehicle 100 equipped with a power supply apparatus 20 according to the embodiment of the invention. As shown in FIG. 1, the electric vehicle 100 is equipped with a motor MG connected to driving wheels 49a and 49b; an inverter 40 that drives the motor MG; a battery 22 that exchanges electric power with the motor MG via the inverter 40; a system main relay 30 provided between the battery 22 and the inverter 40 that electrically connects/disconnects the battery 22 and the inverter 40; a smoothing capacitor 42 provided on the inverter 40 side with respect to the system main relay 30; a relay 44 provided on the inverter 40 side with respect to the system main relay 30 that is connected in parallel with the inverter 40 and the smoothing capacitor 42; and an electronic control unit 70 that controls the entire vehicle. It should be noted herein that the battery 22, the system main relay 30, the smoothing capacitor 42, and the relay 44 mainly correspond to the power supply apparatus 20.

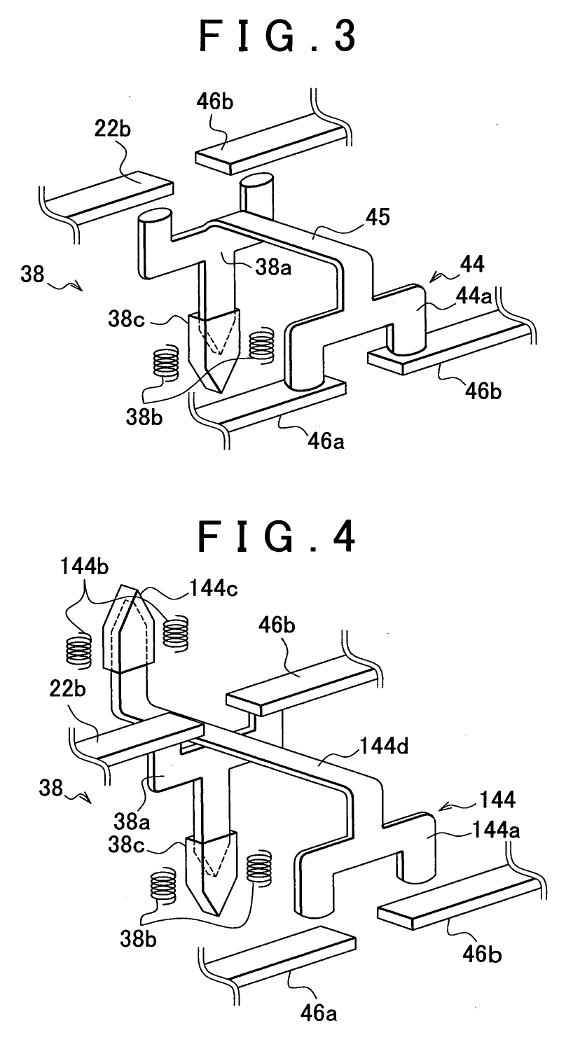

The system main relay 30 is composed of a relay 32 interposed between a positive terminal 22a of the battery 22 and a positive electrode bus 46a, a relay 34 and a resistor 36 that are connected in parallel with the relay 32 to reduce the inrush current when the relay 32 is turned on, and a relay 38 interposed between the negative terminal 22b of the battery 22 and a negative electrode bus 46b. Further, a relay 44 that electrically connects/disconnects the positive electrode bus 46a and the negative electrode bus 46b to/from each other is provided on the inverter 40 side with respect to the system main relay 30. FIGS. 2 and 3 are schematic views of example configurations of the relay 38 and the relay 44. As shown in FIGS. 2 and 3, the relay 38 and the relay 44 each include a conductive contact member 38a, a conductive contact member 44a, an electromagnet 38b, and a case 38c. The contact member 38a comes into contact with the negative terminal 22b of the battery 22 and the negative electrode bus 46b to electrically connect the negative terminal 22b to the negative electrode bus 46b. The contact member 44a comes into contact with the positive electrode bus 46a and the negative electrode bus 46b to electrically connect the positive electrode bus 46a to the negative electrode bus 46b. The contact member 38a is connected to the contact member 44a through a coupling portion 45 that is integrally formed with the contact member 38a and the contact member 44a. The electromagnet 38b moves the contact members 38a and 44a vertically in FIGS. 2 and 3 when a current flows through the electromagnet 38b or stopped from flowing therethrough. The case 38c blocks a portion of the contact member 38a to restrict the movement of the contact members 38a and 44a. It should be noted herein that the case 38c is provided at a position to block further movement of the contact member 38a once the contact member 44a contacts the positive electrode bus 46a and the negative electrode bus 46b. In the relays 38 and 44, when a current flows through the electromagnet 38b, the contact member 44a separates from the positive electrode bus 46a and the negative electrode bus 46b to electrically disconnect the positive electrode bus 46a from the negative electrode bus 46b, and the contact member 38a comes into contact with the negative terminal 22b of the battery 22 and the negative electrode bus 46b to electrically connect the negative terminal 22b to the negative electrode bus 46b via the contact member 38a, as shown in FIG. 2. Further, when the flow of current through the electromagnet 38b is stopped, the contact. member 38a separates from the negative terminal 22b of the battery 22 and the negative electrode bus 46b and instead abuts the case 38c to electrically disconnect the negative terminal 22b from the negative electrode bus 46b, and the contact member 44a comes into contact with the positive electrode bus 46a and the negative electrode bus 46b to electrically connect the positive electrode bus 46a to the negative electrode bus 46b via the contact member 44a, due to an urging force of a spring (not shown), as shown in FIG. 3. That is, the relays 38 and 44 are integrally formed at the contact members 38a and 44a such that the positive electrode bus 46a is electrically connected to the negative electrode bus 46b when the negative terminal 22b of the battery 22 is electrically disconnected from the negative electrode bus 46b. Because the relays 38 and 44 are thus integrally formed, the formation of an electrical connection between the positive electrode bus 46a and the negative electrode bus 46b may be prevented when the negative terminal 22b of the battery 22 and the negative electrode bus 46b are electrically connected to each other. As a result, the likelihood that a short-circuit will occur in the circuit when the battery 22 is connected to the electrode buses 46 is reduced. Further, because the relays 38 and 44 are integrally formed, the number of electromagnets and cases may be reduced in comparison with a power supply apparatus provided with these relays separately. Consequently, the number of controlled targets and parts can be reduced.

The electronic control unit 70 is constructed as a microprocessor having a CPU 72, and is equipped with a ROM 74 in which programs are stored, a RAM 76 in which data are temporarily stored, input/output ports (not shown), and communication ports in addition to the CPU 72. An ignition signal IG from an ignition switch 80; a shift position SP from a shift position sensor 82 that detects an operation position of a shift lever 81; an accelerator operation amount Acc from an accelerator pedal position sensor 84 that detects the operation amount of an accelerator pedal 83; a brake pedal position BP from a brake pedal position sensor 86 that detects a depression amount of a brake pedal 85; a vehicle speed V from a vehicle speed sensor 88; an acceleration a from an acceleration sensor 89 that detects an acceleration of the vehicle; and the like are input to the electronic control unit 70 via the input ports. Drive signals to the system main relay 30, the relay 44, and the inverter 50 are output from the electronic control unit 70. Further, the electronic control unit 70 also detects a collision of the vehicle based on a signal from the acceleration sensor 89.

In the electric vehicle 100, when an operator turns on the ignition switch 80, the system main relay 30 and the relay 44 are driven so that the positive electrode bus 46a is electrically disconnected from the negative electrode bus 46b and the battery 22 is electrically connected to the electrode buses 46, and the inverter 40 is driven such that the motor MG generates an amount of torque corresponding to an amount of depression of the accelerator pedal 83 by the operator to move the electric vehicle 100. Then, when the ignition switch 80 is turned off by the operator or a collision of the vehicle is detected based on a signal from the acceleration sensor 89, the system main relay 30 and the relay 44 are driven such that the battery 22 is electrically disconnected from the electrode buses 46 and the positive electrode bus 46a is electrically connected to the negative electrode bus 46b to discharge the electric power accumulated in the smoothing capacitor 42. As regards the driving of the system main relay 30 and the relay 44, more specifically, when the ignition switch 80 is turned on, the relays 38 and 44 are driven by causing a current to flow through the electromagnet 38b so that the negative terminal 22b of the battery 22 is electrically connected to the negative electrode bus 46b after the positive electrode bus 46a is electrically disconnected from the negative electrode bus 46b, and the relays 32 and 34 are then driven such that the positive terminal 22a of the battery 22 is electrically connected to the positive electrode bus 46a. Further, when the ignition switch 80 is turned off or a collision of the vehicle is detected based on a signal from the acceleration sensor 89, the relay 32 is driven so that the positive terminal 22a of the battery 22 is electrically disconnected from the positive electrode bus 46a, and the flow of current through the electromagnet 38b is stopped so that the positive electrode bus 46a is electrically connected to the negative electrode bus 46b to discharge the electric power accumulated in the smoothing capacitor 42 after the negative terminal 22b of the battery 22 and the negative electrode bus 46b are electrically disconnected from each other. In this manner, when the ignition switch 80 is turned off or a collision of the vehicle is detected, the electric power accumulated in the smoothing capacitor 42 is discharged by the relay 44 after the negative terminal 22b of the battery 22 is disconnected from the negative electrode bus 46b. Therefore, the electric power accumulated in the smoothing capacitor 42 is more reliably and more swiftly discharged. Further, the relays 38 and 44 are designed such that the negative terminal 22b of the battery 22 is electrically disconnected from the negative electrode bus 46b and the positive electrode bus 46a is electrically connected to the negative electrode bus 46b when the flow of current through the electromagnet 38b is stopped. Therefore, even if an inconvenience or the like is caused in the electronic control unit 70 when the vehicle is involved in a collision, the flow of current through the electromagnet 38b is stopped. As a result, the battery 22 may be separated from the electrode buses 46, and the electric power accumulated in the smoothing capacitor 42 is swiftly discharged. Accordingly, with this configuration, the electric power accumulated in the smoothing capacitor 42 may be more reliably and more swiftly discharged.

According to the electric vehicle 100 equipped with the power supply apparatus 20, the relay 44 that is electrically connected/disconnected to/from the battery 22 in parallel with the smoothing capacitor 42 on the inverter 40 side with respect to the system main relay 30 is provided. Therefore, when the system is turned off, the battery 22 is electrically disconnected from the electrode buses 46 by the system main relay 30, and then the positive electrode bus 46a is electrically connected to the negative electrode bus 46b are by the relay 44. As a result, the electric power accumulated in the smoothing capacitor 42 is more reliably and more swiftly discharged. The relays 38 and 44 are integrally formed such that the positive electrode bus 46a is electrically connected to the negative electrode bus 46b when the relay 38 is disconnected. Therefore, the electrical connection of the positive electrode bus 46a and the negative electrode bus 46b is prevented when the battery 22 is electrically connected to the electrode buses 46, thus preventing a short circuit from occurring when the battery 22 is connected to the electrode buses 46.

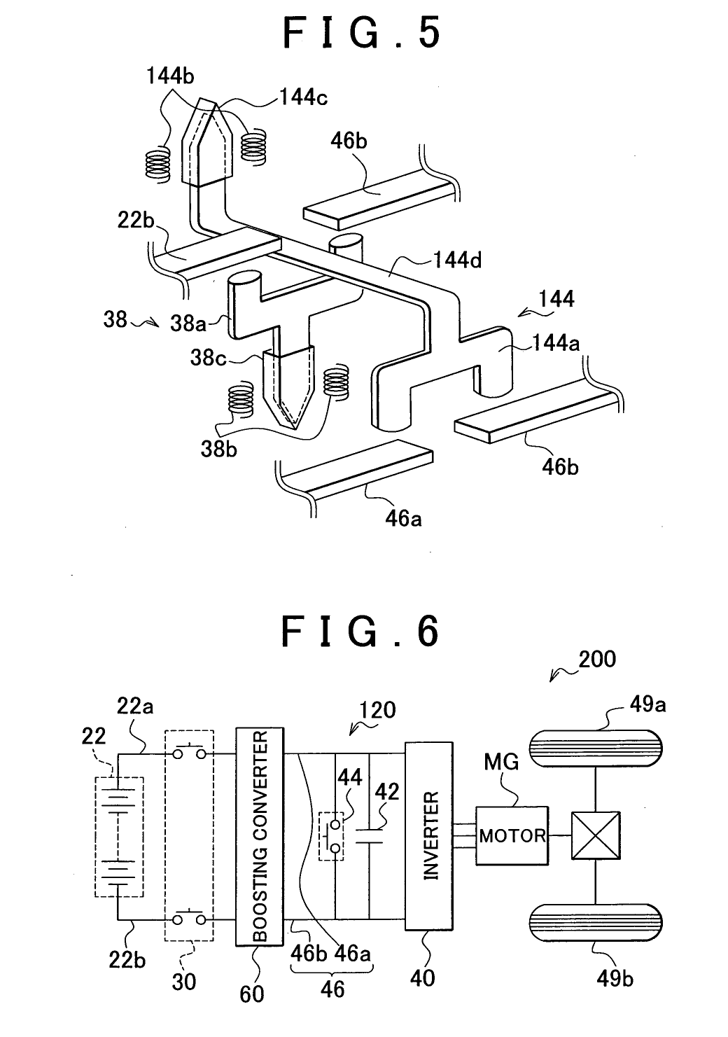

In the electric vehicle 100 equipped with the power supply apparatus 20 according to this embodiment of the invention, the contact member 44a of the relay 44 and the contact member 38a of the relay 38 are integrally formed. However, the contact members 38a and 44a may be formed separately. In this case, when the battery 22 is electrically connected to the electrode buses 46, the relays 38 and 44 may be driven so that the positive electrode bus 46a is not electrically connected to the negative electrode bus 46b. Further, as in the case of the relay 144 according to a modified example of the embodiment shown in FIGS. 4 and 5, the relay 144 may be formed so that the positive electrode bus 46a is not electrically connected to the negative electrode bus 46b as a physical construction when the battery 22 is electrically connected to the electrode buses 46. As shown in FIGS. 4 and 5, the relay 144 according to the modified embodiment is composed of a contact member 144a that comes into contact with the positive electrode bus 46a and the negative electrode bus 46b and thereby electrically connects the positive electrode bus 46a to the negative electrode bus 46b; an electromagnet 144b that moves the contact member 144a vertically in FIGS. 4 and 5 in accordance with whether a current is supplied to the electromagnet 144b; and a case 144c that comes to abut the contact member 144a to restrict movement of the contact member 144a. When a current is supplied to the electromagnet 144b, the contact member 144a separates from the positive electrode bus 46a and the negative electrode bus 46b to electrically disconnect the positive electrode bus 46a from the negative electrode bus 46b. If the supply of current to the electromagnet 144b is stopped, the contact member 144a comes into contact with the positive electrode bus 46a and the negative electrode bus 46b due to an urging force of a spring (not shown) to electrically connect the positive electrode bus 46a to the negative electrode bus 46b. It should be noted herein that the contact member 144a has a crank portion 144d as a plane perpendicular to a direction in which the contact member 144a can move (vertically in FIGS. 4 and 5). By causing a current to flow through the electromagnet 144b and stopping the current from flowing therethrough, the crank portion 144d also moves vertically in FIGS. 4 and 5 as part of the contact member 144a. Then, the relays 38 and 144 are formed such that the crank portion 144d is in contact with the contact member 38a as shown in FIG. 4 even after the flow of current through the electromagnet 144b is stopped, such that the contact member 144a comes into contact with the positive electrode bus 46a and the negative electrode bus 46b when the contact member 38a of the relay 38 is in contact with the negative terminal 22b of the battery 22 and the negative electrode bus 46b, and that the positive electrode bus 46a and the negative electrode bus 46b are electrically connected to each other as shown in FIG. 5 only when the contact member 38a does not contact the negative terminal 22b of the battery 22 and the negative electrode bus 46b. That is, the relays 38 and 144 are formed such that the negative terminal 22b of the battery 22 and the negative electrode bus 46b are not electrically connected to each other when the positive electrode bus 46a is electrically connected to the negative electrode bus 46b. Due to this configuration of the relay 144, even if the relays 38 and 144 are erroneously driven, a short circuit does not occur when the battery 22 is electrically connected to the electrode buses 46.

In the electric vehicle 100 equipped with the power supply apparatus 20, the battery 22 is directly connected to the inverter 40 via the system main relay 30. However, as shown in FIG. 6, an electric vehicle 200 according to the modified embodiment may instead be equipped with a boosting converter 60 that is provided on the inverter 40 side with respect to the system main relay 30 and on the battery 22 side with respect to the smoothing capacitor 42 and the relay 44 to boost the voltage of electric power from the battery 22 and supply the inverter 40 with the electric power. In this case, the electric power whose voltage has been boosted by the boosting converter 60 is accumulated in the smoothing capacitor 42. However, because the same control as that of the first embodiment of the invention is executed, the electric power accumulated in the smoothing capacitor 42 is be more reliably and more swiftly discharged.

In the electric vehicle 100 equipped with the power supply apparatus 20, if a collision of the vehicle is detected based on a signal from the acceleration sensor 89, the battery 22 is electrically disconnected from the electrode buses 46 by the system main relay 30, and the positive electrode bus 46a is electrically connected to the negative electrode bus 46b via the relay 44. Instead of or in addition to the acceleration sensor 89, however, a radar sensor, a camera, or other suitable device, that recognizes objects around the vehicle may be provided to detect or predict the likelihood of collision between the vehicle based on signals from these components and appropriately drive the system main relay 30 and the relay 44.

The power supply apparatus 20 according to the embodiment of the invention has been described as being connected to the motor MG via the inverter 40. However, the power supply apparatus 20 exchanges an electric power with an electric machine. The power supply apparatus 20 may be connected to another electric machine instead of or in addition to the motor and a power generator.

The power supply apparatus 20 according to the embodiment of the invention is mounted on the electric vehicle 100 to exchange an electric power with the motor MG for causing the vehicle to run. However, the power supply apparatus may also provided on a vehicle other than an automobile, for example, a train or the like, or on a moving object such as a ship, an aircraft, or the like. The power supply apparatus may also be incorporated in an immobile plant such as a construction plant or the like.

In the embodiment of the invention, the inverter 40 and the motor MG are equivalent to “the electric machine”; the battery 22 is equivalent to “the direct-current power supply”; the system main relay 30 is equivalent to “the first relay device”; the smoothing capacitor 42 is equivalent to “the smoothing capacitor”; and the relays 44 and 144 are equivalent to “the second relay device”. In addition, the boosting converter 60 is equivalent to “the boosting device”; the acceleration sensor 89 and the electronic control unit 70, which detects a collision of the vehicle based on a signal from the acceleration sensor 89, are equivalent to “the collision detection/prediction device”; and the electronic control unit 70, which drives the system main relay 30 and the relay 44 so that the battery 22 is electrically disconnected from the electrode buses 46 and the positive electrode bus 46a is electrically connected to the negative electrode bus 46b to discharge the electric power accumulated in the smoothing capacitor 42 if a collision of the vehicle is detected, is equivalent to “the collision detection/prediction control device”. It should be noted herein that “the electric machine” is not restricted to the inverter 40 or the motor MG, but may encompass any suitable electric machine that may be employed instead of or in addition to the stated components. “The direct-current power supply” is not restricted to a battery 22, but may encompass any suitable direct-current power supply. “The first relay device” is not restricted to the system main relay 30, but any first relay device that can electrically connect/disconnect the direct-current power supply and the electric machine to/from each other may be employed. “The smoothing capacitor” is not restricted to the smoothing capacitor 42, but may be any suitable smoothing capacitor that is connected to the direct-current power supply in parallel with the electric machine on the electric machine side with respect to the first relay device. “The second relay device” is not restricted to the relay 44 or the relay 144, but may be any suitable relay device that is connected in parallel with the electric machine on the electric machine side with respect to the first relay device. “The boosting device” is not restricted to the boosting converter 60, but may be any suitable voltage boosting device that boosts the voltage of the direct-current power supply on the electric machine side with respect to first relay device and on the direct-current power supply side with respect to the second relay device and the smoothing capacitor and supplies electric power to the electric machine-side. “The collision detection/prediction device” is not restricted to a device that detects the collision of the vehicle based only on the acceleration of the vehicle, but may be any appropriate device that recognizes and identifies objects around the vehicle to detect or predict a collision of the vehicle. “The collision detection/prediction control device” is not restricted to a control device that drives the system main relay 30 and the relay 44 such that the battery 22 is electrically disconnected from the electrode buses 46 and the positive electrode bus 46a and the negative electrode bus 46b are electrically connected to each other to discharge the electric power accumulated in the smoothing capacitor 42 when a collision of the vehicle is detected, but may be any suitable control device that controls the first relay device and the second relay device such that the second relay device is electrically connected after the direct-current power supply and the electric machine are disconnected from each other by the first relay device when a collision of the vehicle is detected or predicted by the collision detection/prediction device. It should be noted that the corresponding relationship between main elements according to the embodiment of the invention and the modified example thereof and main elements mentioned in “SUMMARY OF THE INVENTION” is an example for concretely explaining the mode of carrying out the invention described in “SUMMARY OF THE INVENTION” and hence does not limit the elements mentioned in “SUMMARY OF THE INVENTION”. That is, the invention described in “SUMMARY OF THE INVENTION” should be interpreted on the basis of the description in “SUMMARY OF THE INVENTION”, and the embodiment of the invention is merely a specific example of the invention described in “SUMMARY OF THE INVENTION”.

Although an example embodiment of the invention has been described above, the described embodiment is merely a non-restrictive example of how the invention may be implemented. It is a given that the invention may be implemented in various modes without departing from the scope thereof.

The invention may be employed in industries for manufacturing power supply apparatuses and vehicles and the like.

1-5. (canceled)

6. A power supply apparatus that exchanges an electric power with an electric machine, comprising:
a direct-current power supply;
a first relay device that electrically selectively connects the direct-current power supply to the electric machine;
a smoothing capacitor that is connected in parallel with the direct-current power supply and provided between the first relay device and the electric machine; and
a second relay device that is connected to the direct-current power supply in parallel with the smoothing capacitor on the electric machine side with respect to the first relay device and that selectively connects the smoothing capacitor,
wherein the first relay device and the second relay device are mechanically integrally formed such that the second relay device is electrically connected when the direct-current power supply and the electric machine are disconnected from each other by the first relay device, wherein
the first relay device has a first contact member that electrically selectively connects a first terminal of the direct-current power supply to a bus connected to the electric machine,
the second relay device has a second contact member that electrically selectively connects a second terminal of the direct-current power supply to the bus,
the first contact member is connected to the second contact member via a coupling portion, and
the second contact member comes into contact with the second terminal and the bus when the first contact member is separated from the first terminal and the bus, or
the first relay device has a first contact member that electrically selectively connects a first terminal of the direct-current power supply to a bus connected to the electric machine,
the second relay device has a second contact member that electrically selectively connects a second terminal of the direct-current power supply to the bus,
the second contact member includes a crank portion that extends toward the first contact member,
the second contact member is separated from the second terminal and the bus by the crank portion when the first contact member comes into contact with the first terminal and the bus, and
the second contact member comes into contact with the second terminal and the bus when the first contact member is separated from the first terminal and the bus.

7. The power supply apparatus according to claim 6, further comprising a voltage boosting device that boosts a voltage of electric power provided from the direct-current power supply, wherein the voltage boosting device is provided on the electric machine side with respect to the first relay device, and on the direct-current power supply side with respect to the second relay device and the smoothing capacitor, and wherein the voltage boosting device supplies electric power to the electric machine side.

8. A vehicle equipped with the power supply apparatus according to claim 6, and the electric machine that is an electric motor to/from which a running motive power is input/output.

9. The vehicle according to claim 8, further comprising:
a collision detection device that detects a collision of the vehicle; and
a collision detection control device that controls the first relay device and the second relay device such that the second relay device is electrically connected after the direct-current power supply and the electric machine are disconnected from each other by the first relay device when the collision detection device detects the collision of the vehicle.

10. The vehicle according to claim 8, further comprising:
a collision prediction device that predicts a collision of the vehicle; and
a collision prediction control device that controls the first relay device and the second relay device such that the second relay device is electrically connected after the direct-current power supply and the electric machine are disconnected from each other by the first relay device when the collision prediction device predicts the collision of the vehicle.
